(19) United States
(12) Patent Application Publication
(10) Pub. No.: US 2026/0222769 A1
(43) Pub. Date: Jul. 30, 2026

(54) LIVE LOCATION TRACKING OF AN OFFLINE SECOND ELECTRONIC DEVICE BASED ON AN ASSOCIATED TRANSPORT MOVEMENT

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/038,954

(22) Filed: Jan. 28, 2025

(51) Int. Cl. H04W 4/029

(52) U.S. Cl. CPC H04W 4/029

(57) ABSTRACT

An electronic device provides various techniques for continuing to present an inferred location of a second electronic device after a location service stops receiving location signals from the second electronic device, while the user of the second electronic device is in transit. A processor of the electronic device is configured to cause the electronic device to identify that a user of the second electronic device is aboard a transport carrier. The processor of the electronic device is configured to cause the electronic device to retrieve, from carrier location tracking system(s) associated with the transport carrier, a current carrier location of the transport carrier. The processor of the electronic device is configured to cause the electronic device to generate and render, at a display, a location tracking affordance indicating an inferred current location of the second electronic device based on the current carrier location.

### BACKGROUND

### 1. Technical Field

The present disclosure relates generally to electronic devices capable of receiving location services, and more particularly to electronic devices that share location services with other electronic devices.

### 2. Description of the Related Art

Electronic devices such as smartphones, tables, laptops, and desktop workstations are operated by users for a myriad of functions such as office automation, communication, entertainment, and location services. Portable electronic devices are typically configured with components and/or functional modules that allow the device to provide and/or support location various services. Location services available to these devices can be coupled with digital maps to support navigation applications. Location services can also be extended to groups of two or more electronic devices that can share their respective locations, enabling users to meet up or to track movements of another user, among other purposes.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments; FIG. 2 is a simplified block diagram of a second device location tracking (SDLT) module of the electronic device processing communication records and historical location data to identify a transport carrier that is expected to be a current location of a second electronic device that has stopped reporting location data, according to one or more embodiments; FIG. 3 illustrates a top view diagram of a second user with a second electronic device travelling a path that includes passage on a first transport carrier, according to one or more embodiments;

FIG. 4 illustrates a display of the electronic device presenting a location sharing user interface with an inferred location of the second electronic device, according to one or more embodiments;

FIG. 5 is a flow diagram presenting a computer-implemented method for inferring a current location of a second electronic device based on identifying a location of a transport carrier expected to be carrying a second user of the second electronic device, according to one or more embodiments;

FIG. 6 is a flow diagram presenting a computer-implemented method for accessing information that creates an expectation that a second user of the second electronic is travelling on a transport carrier, according to one or more embodiments; and FIG. 7 is a flow diagram presenting a computer-implemented method augmenting the method of FIG. 5 with a plurality of techniques for identifying the transport carrier and the current location of the transport carrier on which the user is expected to be travelling, according to one or more embodiments.

### DETAILED DESCRIPTION

According to aspects of the present disclosure, an electronic device, a method, and a computer program product provide various techniques for inferring a current location of a second electronic device based on identifying a location of a transport carrier expected to be carrying a user of the second electronic device. Accordingly, while in a location sharing mode, the electronic device continues to provide live location tracking for the second device (via a transport carrier as a proxy) when location reporting data stops, and the second device is "off the grid". Tracking the location of loved ones has evolved from simple verbal updates to sophisticated real-time solutions. Mobile phones have provided an immediacy that was not historically available from other slower modes of communication. The introduction of global positioning system (GPS) in the early 2000s allowed for passive tracking via dedicated GPS receiver devices for self-locating and navigation. Smartphones not only provide these features but also enable live sharing of location between friends and families. Wearables and smartwatches add further convenience, offering real-time tracking and alerts. Today, these technologies provide unparalleled peace of mind, allowing people to instantly monitor the safety of their near and dear ones by using shared location tracking.

However, while modern tracking techniques offer immense peace of mind, these conventional techniques are not always available. When users travel by air, ferries, or even long- distance trains and buses, tracking often becomes unreliable due to lack of signal or device battery life. This gap in location reporting creates anxiety for a loved one who is suddenly faced with uncertainty about a location of a tracked person for extended periods, particularly after becoming accustomed to constant updates. The long durations of such journeys can intensify concerns, as family members are left in the dark about the traveler's whereabouts, amplifying the worry far more than in the pre-tracking era. The present disclosure addresses the issues with current location tracking services and provides further improvements to location sharing. The present disclosure provides techniques for determining, correlating, predicting or inferring that the user is currently being carried by a particular transport carrier (e.g., taxi, bus, airplane, ship, ferry, subway, train, etc.). The inference may be based in part on device location reporting ending at a terminal for the transport carrier. The inference may be based in part on communication records shared by the user indicating a travel itinerary. The inference may be based in part on past location data indicating a commute routine. By determining the current location of a particular transport carrier, the electronic device can determine current location of the electronic device and by extension the device user.

According to one or more embodiments, an electronic device includes a display, a communications subsystem communicatively connectable to a communications network, and a memory including a second device location tracking module. A processor of the electronic device is communicatively coupled to the display, the communications subsystem, and the memory. The processor is configured to cause the electronic device to initiate tracking at the electronic device of a current location of a second electronic device via a first location service that provides second electronic device location data to the electronic device via the communications network. In response to determining that the current location of the second electronic device is not being received from the first location service, while a user of the second electronic device is expected to be travelling with the second electronic device along a route involving one or more transport carriers, the processor is configured to cause the electronic device to identify that the user is aboard a first transport carrier among the one or more transport carriers. The processor is configured to cause the electronic device to retrieve, from one or more carrier location tracking systems associated with the first transport carrier, a current carrier location of the first transport carrier. The processor is configured to cause the electronic device to generate and render, at the display, a location tracking affordance indicating an inferred current location of the second electronic device based on the current carrier location.

According to one or more embodiments, a computer-implemented method is provided for inferring a current location of a second electronic device based on identifying a location of a transport carrier expected to be carrying a user of the second electronic device. The method includes initiating tracking at an electronic device of a current location of a second electronic device via a first location service that provides second electronic device location data to the electronic device via a communications network. In response to determining that the current location of the second electronic device is not being received from the first location service, while a user of the second electronic device is expected to be travelling with the second electronic device along a route involving one or more transport carriers, the method includes identifying that the user is aboard a first transport carrier among the one or more transport carriers. The method includes retrieving, from one or more carrier location tracking systems associated with the first transport carrier, a current carrier location of the first transport carrier. The method includes generating and rendering, at a display, a location tracking affordance indicating an inferred current location of the second electronic device based on the current carrier location.

Further embodiments provide a computer program product that includes: a non- transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to "one embodiment," "an embodiment," "embodiments", or "one or more embodiments" are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms "a", "an", and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

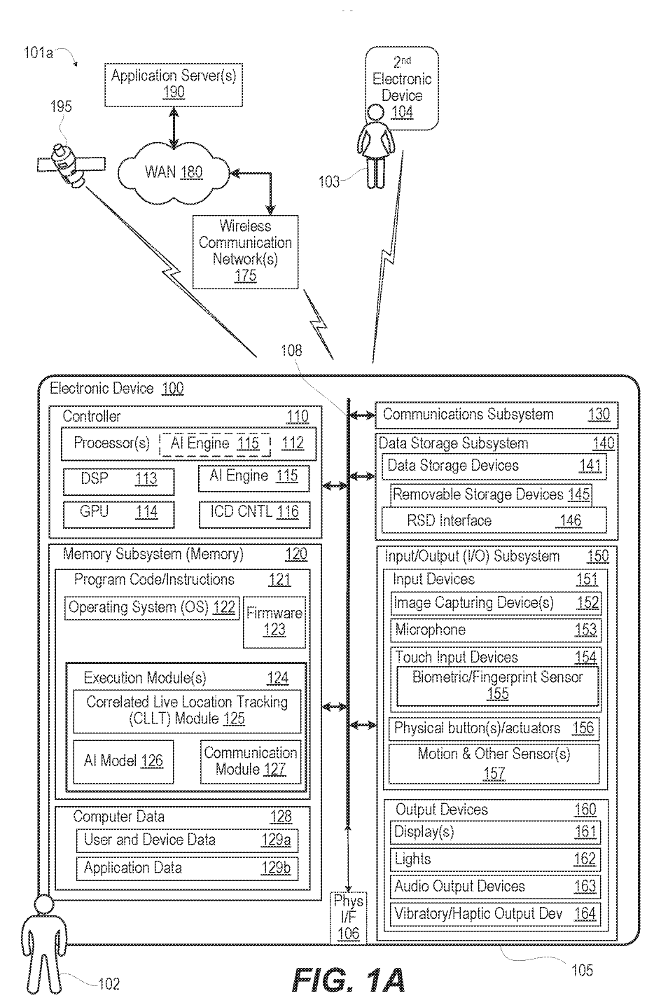

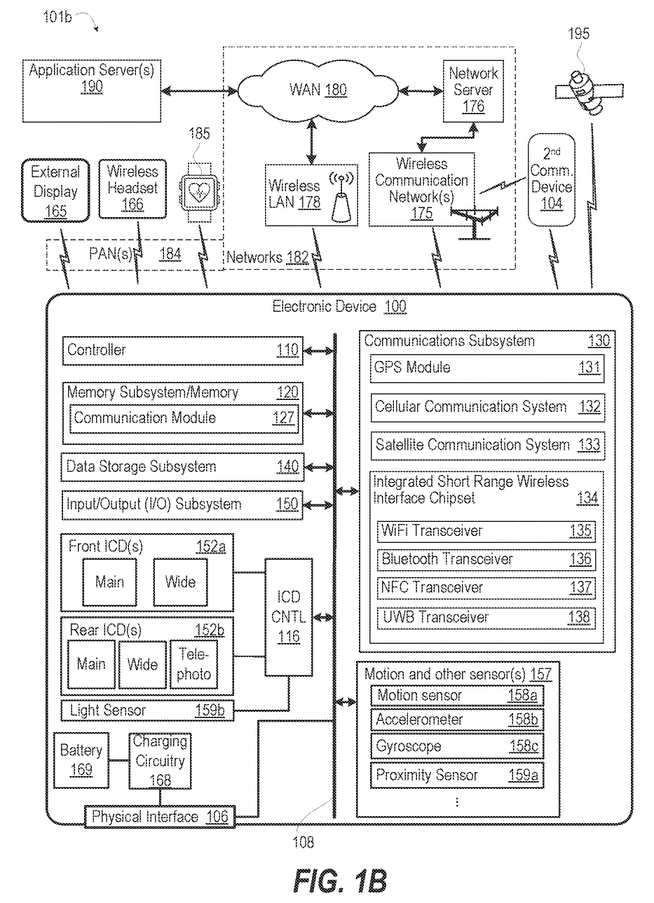

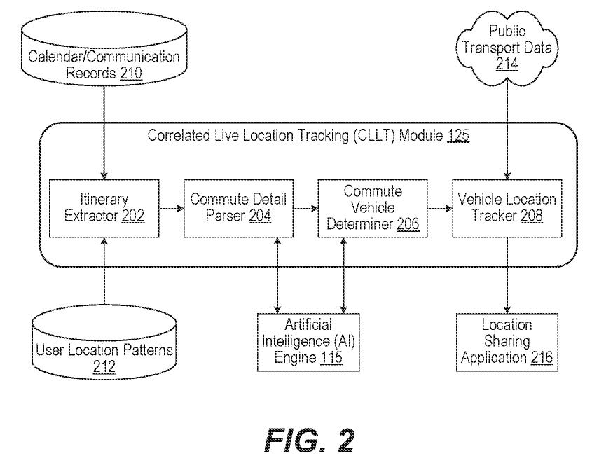

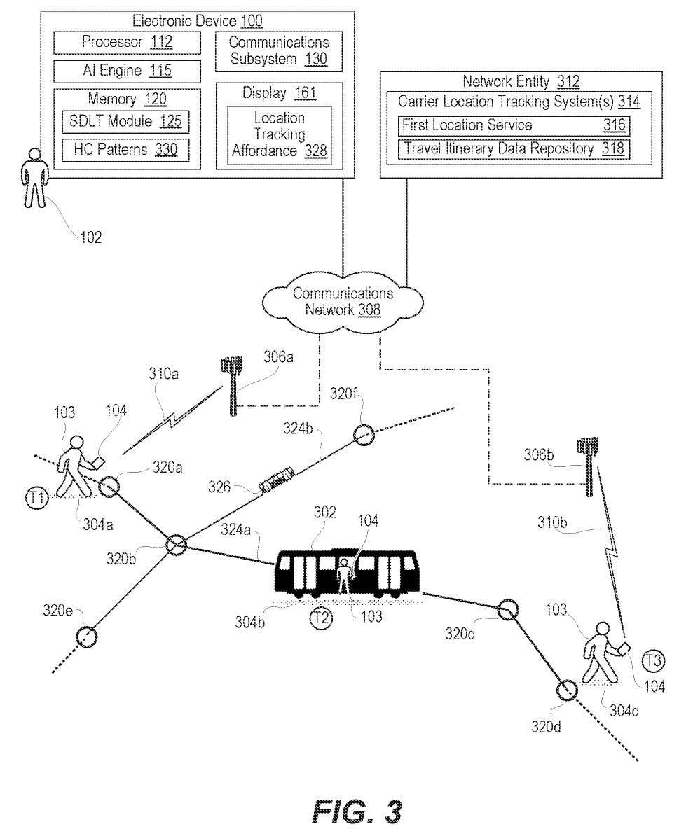

Those of ordinary skill in the art will appreciate that the hardware components and basic configuration depicted in the following figures may vary. For example, the illustrative components within electronic device 100 (FIG. 1A - 1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 provides location sharing features for user 102 to monitor a current location of second user 103 having second electronic 104. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term "communicatively coupled" means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 118.

Memory subsystem (or memory) 120 may include a combination of volatile and non- volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, second device location tracking (SDLT) module 125, which provides the features and operating functionality of the disclosed embodiments when the corresponding program instructions of SDLT module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within SDLT module 125 and is trained to support the AI features of SDLT module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, SDLT module 125 can include program instructions for correlating patterns of reported movement by second electronic device 104 that quits reporting location data after intersecting with a predicted or reported current position of a transport carrier and renew reporting device location data at destination location for the transport carrier. For another example, SDLT module 125 can include program instructions that cause or configure processor 112 to cause electronic device 100 to associate user activities of second user 103 with communication records, calendar entries, etc., such as by using natural language processing. Other features provided by SDLT module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate "data" that originated as raw, real-world "analog" information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of SDLT module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100.

Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment lOb that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of SDLT module 125 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

FIG. 2 is a simplified block diagram of second device location tracking (SDLT) module 125 of electronic device 100 that includes itinerary extractor 202, commute detail parser 204, commute vehicle determiner 206 and vehicle location tracker 208. Itinerary extractor 202 receives information from calendar/communication records 210 and user location patterns 212. Itinerary extractor 202 extracts the itinerary (e.g., date, time, departure location, destination, carrier, etc.) of second user 103 (FIG. 1A) from messages in calendar/communication records 210. With benefit of raw data extracted by itinerary extractor 202, commute detail parser 204 parses the information for commute number(s) for individual flight(s), train(s), bus(es), ferry(ies), etc. with corresponding schedule information. For commute information missing in the raw data, commute detail parser 204 tags these omissions for retrieval. In one or more embodiments, artificial intelligence (AI) engine 115 recommends information to complete the commute details. With the benefit of the commute number(s), vehicle location tracker 208 accesses public transport detail information 214 to extract live location for the commute number(s). In one or more embodiments, artificial intelligence (AI) engine 115 recommends information to locate the public transport detail information 214. In an example, a carrier may provide tracking data via a website or via a carrier app. Vehicle location tracker 208 provides the live location to location sharing application 216 for presenting to user 102 (FIG. 1A). SDLT module 125 provides techniques for live location tracking that is a combination of actual location data from second electronic device 104 (FIG. 1A) and inferred location data associated with a transport carrier.

FIG. 3 illustrates a top view diagram of second user 103 with second electronic device 104 travelling a path that includes passage on first transport carrier 302. At a first time "T1", second electronic device 104 is at first location 304a and is in communication with node 306a (e.g., RAN, access point, base station, etc.) of communications network 308. Second communication device 104 is providing location data via communication channel 310a via node 306a and communications network 308 to one or more network entity 312 that supports carrier location tracking system(s) 314. Carrier location tracking system(s) 314 includes first location service 316 and travel itinerary data repository 318, both associated with at least first transport carrier 302. First location service 316 has live location data for second electronic device 104.

In an example, first location 304a is proximate to first carrier stop 320a of first carrier route 324a that supports first transport carrier 302. First carrier route 324a also sequentially includes second carrier stop 320b, third carrier stop 320c, and fourth carrier stop 320d and includes fifth carrier stop 320e and sixth carrier stop 320f in opposite directions to second carrier stop 320b. Second carrier route 324b supports second transport carrier 326, which provides an intersection with first carrier route 324a. User 103 boards first transport carrier 302 at first carrier stop 320a and remains on first transport carrier 302 until fourth carrier stop 320d. In between second and third carrier stops 320b- 320c at second time "T2" and at second location 304b , second communication device 104 is not in communication with (i.e., is not transmitting a location signal with) first location service 316. As an example, second communication device 104 can be turned off, e.g., to save battery power, or second communication device 104 may be out of communication range of a communication/radio tower (e.g., communications network 308), such as while in an airplane or in the middle of the ocean. As another example, second communication device 104 can be in a suspended communication mode, e.g., in airplane mode while on board an airplane, to comply with transportation carrier requirements. Irrespective of the reason, at second time T2, first location service 316 does not have live location data for second electronic device 104. Second location 304b of first transport carrier 302 at second time "T2" is discernible from travel itinerary data repository 318. At third time "T3", user 103 has left first transport carrier 302 carrying second electronic device 104 and is at third location 304c. Second electronic device 104 is in communication via second communication channel 310b and second node 306b to communications network 308. First location service 316 again has live location data for second electronic device 104.

For clarity, user 103 uses one transport carrier during a journey or commute monitored by electronic device 100. However, electronic device 100 may infer a more complicated routing that includes changes in transport carriers of two or more types along a multi-carrier commute route (e.g., plane to underground subway to ferry). In one or more embodiments, electronic device 100 may successfully communicate with first location service 316 while being carried by first transport carrier 302, increasing confidence by electronic device 100 that second user 103 is aboard first transport carrier 302. In one or more embodiments, electronic device 100 may infer that second user 103 is aboard first transport carrier based solely on a known historical commuting pattern in combination with a reported proximity of electronic device 100 to a departure location of first transport carrier 302.

According to aspects of the present disclosure, electronic device 100 has display 161 and memory 120, which includes second device location tracking (SDLT) module 125. Electronic device 100 includes communications subsystem 130 communicatively connectable to communications network 308. Processor 112 of electronic device 100 is communicatively coupled to display 161, memory 120, and communications subsystem 130. Processor 112 is configured to cause electronic device 100 to initiate tracking at electronic device 100 of a current location (e.g., first location 304a) of second electronic device 104 via first location service 316 that provides second electronic device location data to electronic device 100 via communications network 308. In response to determining that the current location (e.g., second location 304b) of second electronic device 104 is not being received from first location service 316, while second user 103 of second electronic device 104 is expected to be travelling with second electronic device 104 along a route (e.g., first carrier route 324a) involving one or more transport carriers, processor 112 is configured to cause electronic device 100 to identify that second user 103 is likely aboard first transport carrier 302 among the one or more transport carriers. Processor 112 is configured to cause electronic device 100 to retrieve, from one or more carrier location tracking systems 314 associated with first transport carrier 302, a current carrier location (e.g., second location 304b) of first transport carrier 302. Processor 112 is configured to cause electronic device 100 to generate and render, at display 161, location tracking affordance 328 indicating an inferred current location of second electronic device 104 based on the current carrier location (e.g., second location 304b).

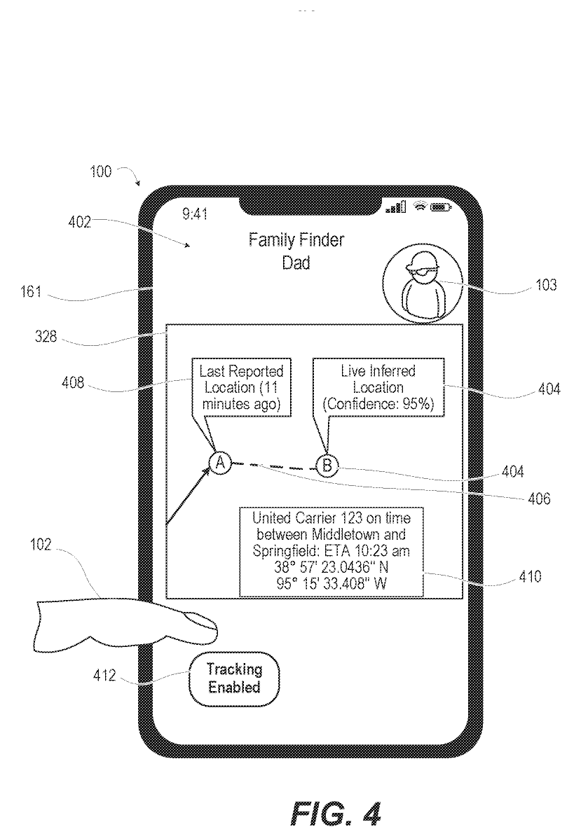

FIG. 4 illustrates display 161 of electronic device 100 presenting location sharing user interface 402 with an inferred location (i.e., location "B" 404 indicated as having 95% confidence) of second electronic device 104 associated with second user 103 ("Dad") of FIG. 3. In an example, location tracking affordance 328 may present a predicted path 406 of user 103 (FIG. 3) including the last reported location "A" 408 and indicate a basis for the inferred current location such as identification 410 of first transport carrier. Location sharing user interface 402 includes controls, such as tracking toggle control 412, to enable user 102 to select second user for shared location tracking.

With returning reference to FIG. 3, in one or more embodiments, processor 112 is configured to cause electronic device 100 to identify that second user 103 is aboard first transport carrier 302 based at least in part on accessing travel itinerary data associated with second user 103, e.g., accessed from within calendar/communication records 210 (FIG. 2). In one or more particular embodiments, processor 112 is configured to cause electronic device 100 to identify the current carrier location (e.g., second location 304b) of first transport carrier 302 by extrapolating the current carrier location based on the travel itinerary data. In one or more specific embodiments, the travel itinerary data includes a group of one or more of: (i) time of departure; (ii) estimated time of arrival; and (iii) geographical route.

In one or more embodiments, processor 112 is configured to cause electronic device 100 to identify that second user 103 is aboard first transport carrier 302 based at least in part on a last received location (e.g., first location 304a) and a travel path of second electronic device 104 indicating second electronic device 104 was approaching, was at, or was proximate to a departure point (e.g., first transport stop 320a) of first transport carrier 302 prior to the current location of second electronic device 104 no longer being received from first location service 316. In one or more embodiments, processor 112 is configured to cause electronic device 100 to identify that second user 103 is aboard first transport carrier 302 based at least in part on accessing historical commuting (HC) patterns 330 stored in memory 120 and associated with second user 103. In one or more embodiments, processor 112 is configured to cause electronic device 100 to identify the current carrier location (e.g., second location 304b) of first transport carrier 302 by accessing network entity 312 that tracks and/or posts the current carrier location. In one or more embodiments, at a subsequent time, in response to detecting receipt of a next transmitted current location (e.g., third location 304c) of second electronic device 104 from first location service 316, processor 112 is configured to cause electronic device 100 to render and present, at display 161, location tracking affordance 328 indicating an actual current location of second electronic device 104.

In one or more embodiments, electronic device 100 includes artificial intelligence (AI) engine 115 trained using historical commuting (HC) patterns 330 of user transportation and carrier movement. HC patterns 330 may be based on monitoring second electronic device 104. Alternatively, or in addition, HC patterns 330 may be based on monitoring other electronic devices used by other users. Processor 112 is configured to cause electronic device 100 to identify that second user 103 is aboard first transport carrier 302 and determine a current location (e.g., second location 304b) of first transport carrier 302 using AI engine 115.

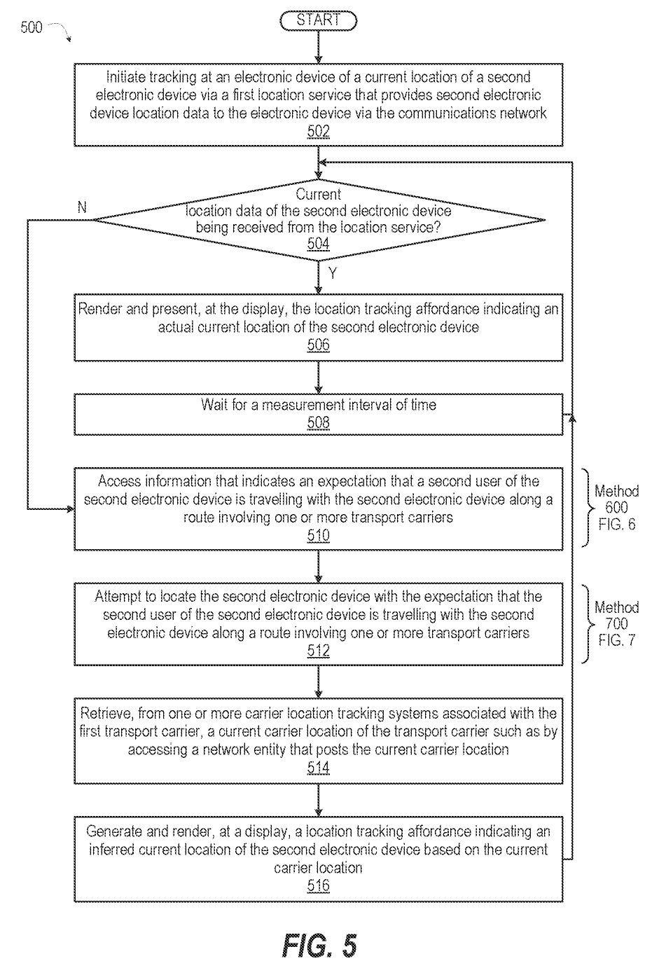

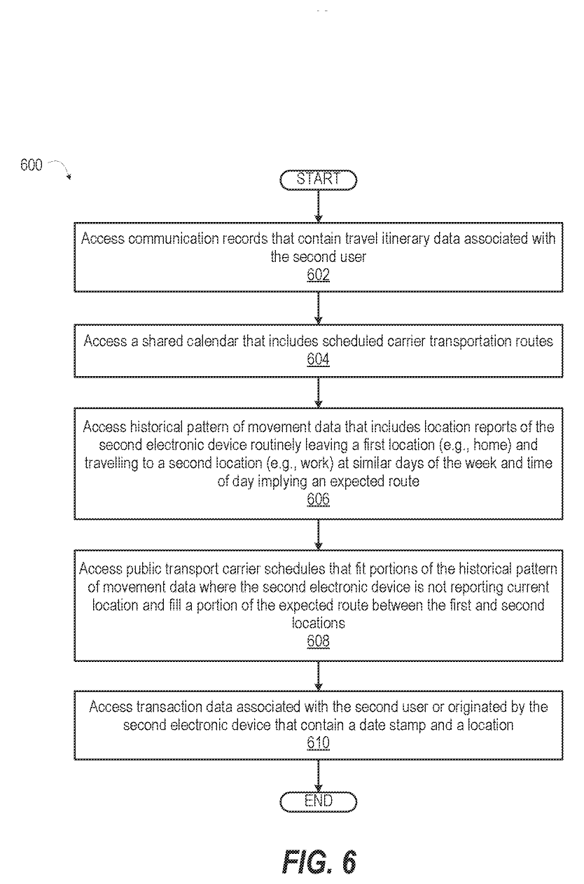

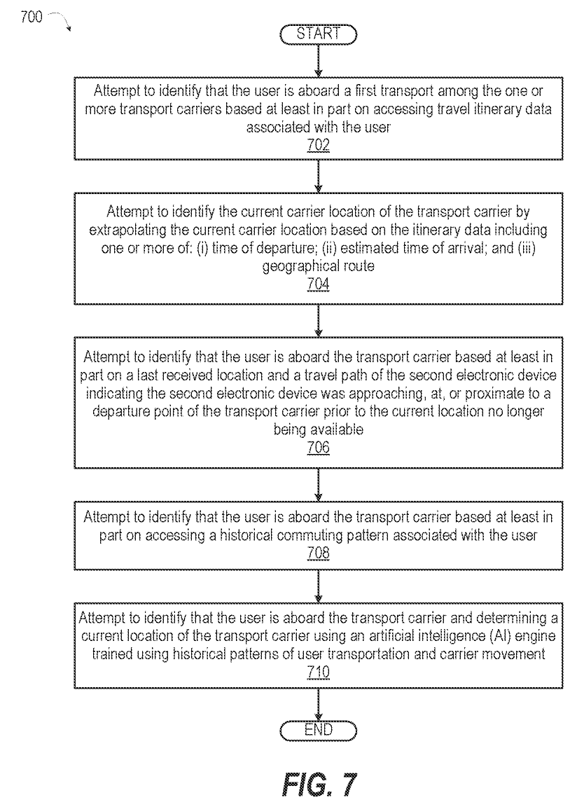

FIG. 5 is a flow diagram presenting computer-implemented method 500 for inferring a current location of a second electronic device based on identifying a location of a transport carrier expected to be carrying a second user of the second electronic device. FIG. 6 is a flow diagram presenting computer-implemented method 600 augmenting method 500 (FIG. 5) with a plurality of techniques for accessing information and processing the information that creates an expectation that the second user of the second electronic is travelling on a transport carrier. FIG. 7 is a flow diagram presenting computer-implemented method 700 augmenting method 500 (FIG. 5) with a plurality of techniques for identifying the transport carrier and the current location of the transport carrier expected to be carrying the user. The descriptions of method 500 (FIG. 5), method 600 (FIG. 6), and method 700 (FIG. 7) are provided with general reference to the specific components illustrated within the preceding FIGS. 1A-1B and 2-4. Specific components referenced in method 500 (FIG. 5), method 600 (FIG. 6), and method 700 (FIG. 7) may be identical or similar to components of the same name used in describing preceding FIGS. 1A-1B and 2-4. In one or more embodiments, controller 110 (FIG. 1A) configures electronic device 100 (FIGS. 1A-1B) or a similar computing device to provide the described functionality of method 500 (FIG. 5), method 600 (FIG. 6), and method 700 (FIG. 7).

With reference to FIG. 5, method 500 includes initiating tracking at an electronic device of a current location of a second electronic device via a first location service that provides second electronic device location data to the electronic device via the communications network (block 502). Method 500 includes determining whether the current location data of the second electronic device is being received from the location service (block 504). In response to determining that the current location data of the second electronic device is being received from the location service, method 500 includes rendering and presenting, at the display, the location tracking affordance indicating an actual current location of the second electronic device (block 506). Method 500 includes waiting for a measurement interval of time (block 508). Method 500 returns to block 504.

In response to determining, in decision block 504, that the current location data of the second electronic device is not (i.e., no longer) being received from the location service, method 500 includes accessing information that indicates an expectation that a second user of the second electronic device is travelling with the second electronic device along a route that involves one or more transport carriers (block 510). Examples of the information and processing of the information is provided below with regard method 600 of FIG. 6.

With continuing reference to FIG. 5, method 500 includes activating processes for attempts to locate the second electronic device, using an assumption, deduction from secondary data, or historical knowledge that a second user of the second electronic device is travelling with the second electronic device along a route that involves one or more transport carriers (block 512). Method 700 of FIG. 7 includes examples of various processes for attempting to identify that the user is aboard a particular transport whose location may be determined. With continuing reference to FIG. 5, method 500 includes retrieving, from one or more carrier location tracking systems associated with a first transport carrier, a current carrier location of the transport carrier (block 514). For example, in one or more embodiments, method 500 can include accessing a network entity that posts the current carrier location. Method 500 includes generating and rendering, at a display, a location tracking affordance indicating an inferred current location of the second electronic device based on the current carrier location (block 516). Then method 500 returns to block 508. According to one aspect of the disclosure, one or more embodiments provide that the second location tracking affordance is visibly discernible from the original location tracking affordance so as to visually inform the user that the presented location is a proxy based on the carrier location versus an actual detected/received location of the second electronic device.

According to aspects of the present disclosure, method 500 may include initiating tracking at an electronic device of a current location of a second electronic device via a first location service that provides second electronic device location data to the electronic device via a communications network. In response to determining that the current location of the second electronic device is not being received from the first location service, while a user of the second electronic device is expected to be travelling with the second electronic device along a route involving one or more transport carriers, method 500 may include identifying that the user is aboard a first transport carrier among one or more transport carriers. Method 500 may include retrieving, from one or more carrier location tracking systems associated with the first transport carrier, a current carrier location of the first transport carrier. Method 500 may include generating and rendering, at a display, a location tracking affordance indicating an inferred current location of the second electronic device based on the current carrier location.

With reference to FIG. 6, in one or more embodiments, method 600 may include accessing communication records that contain travel itinerary data associated with the second user (block 602). In an example, the travel itinerary data may include tickets, receipts, reservation confirmations, etc. In an example, the second user may type, dictate, or forward the travel itinerary data in a chat, direct messaging or email service that is transmitted to the electronic device. Alternatively, or in addition, method 600 may include accessing a shared calendar that includes scheduled carrier transportation routes (block 604). Alternatively, or in addition, method 600 may include accessing historical pattern of movement data that includes location reports of the second electronic device routinely leaving a first location (e.g., home) and travelling to a second location (e.g., work) at similar days of the week and time of day, implying an expected route (block 606). The expected route enables extrapolating a current location from the last reported location during periods in which the second electronic device is not reporting its current location. In an example, the second user may be on a transport carrier that does not report location and does not run on a schedule (e.g., private taxi). Alternatively, method 600 may include accessing public transport carrier schedules that fit portions of the historical pattern of movement data where the second electronic device is not reporting current location and fill in a portion of the expected route between the first and second locations (block 608). In one or more embodiments, method 600 includes accessing transaction data associated with the second user or originated by the second electronic device that contain a date stamp and a location (block 610). In an example, the user and the second user may both have a shared financial account or access to monitor a financial account (e.g., a credit card) used by the second user. Then method 600 ends.

With reference to FIG. 7, in one or more embodiments, method 700 includes attempting to identify that the second user of the second electronic device is aboard a first transport among the one or more transport carriers based at least in part on accessing travel itinerary data associated with the second user (block 702). Alternatively, or in addition, method 700 may include attempting to identify the current carrier location of the transport carrier by extrapolating the current carrier location based on the itinerary data including one or more of: (i) time of departure; (ii) estimated time of arrival; and (iii) geographical route (block 704). Alternatively, or in addition, method 700 may include attempting to identify that the user is aboard the transport carrier based, at least in part, on a last received location and a travel path of the second electronic device indicating the second electronic device was approaching, at, or proximate to a departure point of the transport carrier prior to the current location no longer being available (block 706). In one or more embodiments, alternatively, or in addition, method 700 includes attempting to identify that the user is aboard the transport carrier based at least in part on accessing the historical commuting pattern associated with the user (e.g., user location patterns 212 (FIG. 2) (block 708). In one or more embodiments, alternatively, or in addition, method 700 includes attempting to identify that the user is aboard the transport carrier and determining a current location of the transport carrier using an artificial intelligence (AI) engine trained using historical patterns of user transportation and carrier movement (block 710).

In one or more embodiments, method 600 may further include identifying that the user is aboard the first transport carrier based at least in part on a last received location and a travel path of the second electronic device indicating the second electronic device was approaching, was at, or was proximate to a departure point of the first transport carrier prior to the current location of the second electronic device no longer being received from the first location service.

In one or more embodiments, method 600 may further include identifying that the user is aboard the first transport carrier based at least in part on accessing a historical commuting pattern associated with the user. In one or more embodiments, method 600 may further include identifying the current carrier location of the first transport carrier by accessing a network entity that posts the current carrier location.

In one or more embodiments, at a subsequent time, in response to detecting receipt of a next transmitted current location of the second electronic device from the first location service, method 600 may further include rendering and presenting, at the display, the original location tracking affordance indicating an actual current location of the second electronic device. In one or more embodiments, an inferred location is depicted differently from a transmitted location. In an example, the shape and color of a location pin may differ. In another example, a text label may indicate whether the location is transmitted or inferred. In one or more embodiments, method 600 may further include identifying that the user is aboard the first transport carrier and determining a current location of the first transport carrier using an artificial intelligence (AI) engine trained using historical patterns of user transportation and carrier movement.

According to aspects of the present disclosure, the electronic device 100 (FIG. 1A), method 500 (FIG. 5), method 600 (FIG. 6), method 700 (FIG. 7), and computer program product, such as RSD 145 (FIG. 1A), provide techniques for inferring a current location of a second electronic device based on identifying a location of a transport carrier expected to be carrying a user of the second electronic device. The techniques automatically identify a transport carrier that is carrying a user of the electronic device by one or more approaches (e.g., historical commuting pattern proximity and timing of last location reporting to departure of a particular transport carrier), increasing the likelihood and confidence in a correct identification. The techniques enable live location tracking even during periods when the second electronic device is not reporting location data and is "off the grid", such as due to being unable transmit a signal (e.g., turned off, in airplane mode, has a fully discharged battery, out of service area, or shielded by the transport carrier).

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a "circuit," "module" or "system."

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms "a", "an" and "the" are intended to include the plural forms as well, unless the context clearly indicates otherwise. It will be further understood that the terms "comprise" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device, comprising:
a display;
a communications subsystem communicatively connectable to a communications network;
a memory comprising a second device location tracking module; and
a processor communicatively coupled to the display, the communications subsystem; and the memory, and which is configured to cause the electronic device to:
initiate tracking at the electronic device of a current location of a second electronic device via a first location service that provides second electronic device location data to the electronic device via the communications network; and
in response to determining that the current location of the second electronic device is not being received from the first location service, while a user of the second electronic device is expected to be travelling with the second electronic device along a route involving one or more transport carriers:
identify that the user is aboard a first transport carrier among the one or more transport carriers;
retrieve, from one or more carrier location tracking systems associated with the first transport carrier, a current carrier location of the first transport carrier; and
generate and render, at the display, a location tracking affordance indicating an inferred current location of the second electronic device based on the current carrier location.

2. The electronic device of claim 1, wherein the processor is configured to cause the electronic device to:
identify that the user is aboard the first transport carrier based at least in part on accessing travel itinerary data associated with the user.

3. The electronic device of claim 2, wherein the processor is configured to cause the electronic device to:
identify the current carrier location of the first transport carrier by extrapolating the current carrier location based on the travel itinerary data.

4. The electronic device of claim 3, wherein the travel itinerary data comprises a group of one or more of: (i) time of departure; (ii) estimated time of arrival; and (iii) geographical route.

5. The electronic device of claim 1, wherein the processor is configured to cause the electronic device to:
identify that the user is aboard the first transport carrier based at least in part on a last received location and a travel path of the second electronic device indicating the second electronic device was approaching, was at, or was proximate to a departure point of the first transport carrier prior to the current location of the second electronic device no longer being received from the first location service.

6. The electronic device of claim 1, wherein the processor is configured to cause the electronic device to:
identify that the user is aboard the first transport carrier based at least in part on accessing a historical commuting pattern associated with the user.

7. The electronic device of claim 1, wherein the processor is configured to cause the electronic device to:
identify the current carrier location of the first transport carrier by accessing a network entity that posts the current carrier location.

8. The electronic device of claim 1, wherein the processor is configured to cause the electronic device to:
at a subsequent time, in response to detecting receipt of a next transmitted current location of the second electronic device from the first location service, render and present, at the display, the location tracking affordance indicating an actual current location of the second electronic device.

9. The electronic device of claim 1, further comprising an artificial intelligence (AI) engine trained using historical patterns of user transportation and carrier movement, and wherein the processor is configured to cause the electronic device to:
identify that the user is aboard the first transport carrier and determine a current location of the first transport carrier using the AI engine.

10. A method, comprising:
initiating tracking at an electronic device of a current location of a second electronic device via a first location service that provides second electronic device location data to the electronic device via a communications network; and
in response to determining that the current location of the second electronic device is not being received from the first location service, while a user of the second electronic device is expected to be travelling with the second electronic device along a route involving one or more transport carriers:
identifying that the user is aboard a first transport carrier among the one or more transport carriers;
retrieving, from one or more carrier location tracking systems associated with the first transport carrier, a current carrier location of the first transport carrier; and
generating and rendering, at a display, a location tracking affordance indicating an inferred current location of the second electronic device based on the current carrier location.

11. The method of claim 10, further comprising:
identifying that the user is aboard the first transport carrier based at least in part on accessing travel itinerary data associated with the user.

12. The method of claim 11, further comprising:
identifying the current carrier location of the first transport carrier by extrapolating the current carrier location based on the travel itinerary data.

13. The method of claim 12, wherein the travel itinerary data comprises a group of one or more of: (i) time of departure; (ii) estimated time of arrival; and (iii) geographical route.

14. The method of claim 10, further comprising:
identifying that the user is aboard the first transport carrier based at least in part on a last received location and a travel path of the second electronic device indicating the second electronic device was approaching, was at, or was proximate to a departure point of the first transport carrier prior to the current location of the second electronic device no longer being received from the first location service.

15. The method of claim 10, further comprising:
identifying that the user is aboard the first transport carrier based at least in part on accessing a historical commuting pattern associated with the user.

16. The method of claim 10, further comprising:
identifying the current carrier location of the first transport carrier by accessing a network entity that posts the current carrier location.

17. The method of claim 10, further comprising:
at a subsequent time, in response to detecting receipt of a next transmitted current location of the second electronic device from the first location service, rendering and presenting, at the display, the location tracking affordance indicating an actual current location of the second electronic device.

18. The method of claim 10, further comprising:
identifying that the user is aboard the first transport carrier and determining a current location of the first transport carrier using an artificial intelligence (AI) engine trained using historical patterns of user transportation and carrier movement.

19. A computer program product comprising:
a computer readable storage device; and
program code on the computer readable storage device that when executed by a processor associated with an electronic device, the program code is configured to cause the electronic device to provide functionality of:
initiating tracking at the electronic device of a current location of a second electronic device via a first location service that provides second electronic device location data to the electronic device via a communications network; and
in response to determining that the current location of the second electronic device is not being received from the first location service, while a user of the second electronic device is expected to be travelling with the second electronic device along a route involving one or more transport carriers:
identifying that the user is aboard a first transport carrier among the one or more transport carriers;
retrieving, from one or more carrier location tracking systems associated with the first transport carrier, a current carrier location of the first transport carrier; and
generating and rendering, at a display, a location tracking affordance indicating an inferred current location of the second electronic device based on the current carrier location.

20. The computer program product of claim 19, wherein the program code is further configured to cause the electronic device to provide functionality of:
identifying that the user is aboard the first transport carrier based at least in part on accessing travel itinerary data associated with the user; and
identifying the current carrier location of the first transport carrier by extrapolating the current carrier location based on the travel itinerary data comprising a group of one or more of: (i) time of departure; (ii) estimated time of arrival; and (iii) geographical route.
